(19) United States
(12) Patent Application Publication
(10) Pub. No.: US 2009/0138276 A1
(43) Pub. Date: May 28, 2009

(54) PRIVACY MANAGEMENT SYSTEM USING USER'S POLICY AND PREFERENCE MATCHING

(75) Inventors: Norimasa Hayashida, Tokyo (JP); Hiroshi Nomiyama, Kawasaki-shi (JP); Atsushi Sato, Yokohama-shi (JP); Akiko Suzuki, Kawasaki-shi (JP)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/324,862

(22) Filed: Nov. 27, 2008

(30) Foreign Application Priority Data
Nov. 27, 2007 (JP) 2007-305280

(51) Int. Cl. G06Q 99/00

(52) U.S. Cl. 705/1

(57) ABSTRACT

By applying a privacy policy, which describes and manages a policy for disclosure of preference information, to the preference information, it is determined whether or not to disclose some or all of the information to a third party based on classification as a result of matching by a matching system. The description of a privacy policy makes it possible to achieve a meaningful communication by disclosing preference information to others within a detailed range while keeping the preference information undisclosed if the user does not wish disclosure thereof, such as disclosing only preference information including preferences matching those of the other user or disclosing only preference information including preferences shared in a certain user group.

### BACKGROUND OF THE INVENTION

The present invention relates to a system, a method and a program for disclosing user's preference information in an environment where multiple users interact or communicate with each other on an online network, such as a social networking service (SNS) and a virtual space.

More specifically, the present invention relates to a technique of disclosing hobbies or preferences, in a mode specified by a user, to another user.

Along with the development of online communications, privacy protection has become an important issue. In this respect, hobbies and preferences are regarded as important elements of privacy. Therefore, no one is normally willing to disclose, without caution, his/her hobby and preference to anybody else.

While hobbies, preferences and the like belong to a person as his/her private information, at the same time, it is important to share the preferences in a communication between people. Specifically, in a situation where a person talks with a person who he/she met for the first time, he/she can start to communicate easily if he/she knows the people's preferences which may match or not match with his/her preferences.

As conventional techniques for solving such a problem, a method has been used wherein people describe their hobbies or preferences in their own profiles or the like and refer others' hobbies or preferences by system, or utilize such descriptions for retrieval or matching. Moreover, there has also been known a method for extracting preference information from a user's activity log and the contents (postings, comment on a blog and mail messages) and the like. This method includes away for simply extracting a noun as a target and a way for extracting a target object with expression of evaluation and the like for the target object. However, even if a user writes, blogs or makes a conversation (such as a chat) in the public, the user does not want other people to know such kinds of preference information, since the users change their attitudes in the writing or the posting message depending on who is going to read the writing or the posting message. Accordingly, even if a user discloses an original content from which the user's preferences are extracted, the user hesitates to allow disclosing all of the automatically-extracted preference information.

For a person having such a concern, a method for determining a policy of information disclosure has been known. This method makes it possible to determine disclosure or nondisclosure of preference information to others by use of a description of a disclosure policy. However, a way for specifying individuals (or a group thereof) one by one as a target for disclosing the information can only be adopted for this method. Thus, only a binary determination, either nondisclosure or disclosure, can be made for unknown users. Such a method cannot properly cope with a situation where the user wishes to use preference information in communication with unknown people.

Japanese Unexamined Patent Application Publication No. HEI11-345248 discloses the following technique intended to prevent invasion of privacy due to unexpected disclosure of user profile information required to select information matching user's preferences. Specifically, the user profile information recorded in an IC card is read by use of a terminal device and the information is transmitted to a host computer. The host computer selects provision information (product information) received based on the profile information received, and provides the provision information matching the user's preferences by transmitting the information to the user's terminal device. In this technique, the profile information recorded on the IC card is ranked from A to C according to confidential levels. Thus, it is possible to set by the user operation to which rank of the profile information is allowed to be disclosed.

Japanese Unexamined Patent Application Publication No. 2002-108920 discloses the following technique intended to provide an information providing method which enables a user to receive a service adapted to preferences of the user while protecting the user's privacy. Specifically, personal information of the user is managed by a user information management part in a portal site server. When a request for information is sent to an information site server from the user's terminal device, personal information including contents such as hobbies and preferences of the user is transmitted to the information site server from the portal site server. Then, the information site server transmits, to the user's terminal device, information including contents adapted to the received personal information.

Japanese Unexamined Patent Application Publication No. 2007-102635 discloses the following technique intended to recommend a blog community suitable for each end user as a communication space, based on community attributes and matching of preferences of the end user related to the community attributes. Specifically, a blog community analyzer analyzes contents of each blog, which constitutes a community, based on community definition information. Thereafter, blog community information that matches community recommendation conditions is retrieved by calculating any one or more of community attributes information including scale, activity level and openness. Subsequently, community information obtained as the retrieval result is displayed on a screen in response to a request from an end user's terminal.

The conventional technologies described above make it possible to prevent the profile information such as the preference information from leaking to the others. However, it is still impossible to properly control disclosure or nondisclosure of the preference information to an unknown third party.

### SUMMARY OF THE INVENTION

According to the present invention, a range of disclosure of privacy is set by a user himself/herself using a policy document and preference information is extracted from an action history of the user (such as a posting message history, a document writing history and actions) and then disclosed.

The present invention typically has the following two systems. The first system is a system for extracting preference information from a document or information disclosed by a user himself/herself and for managing the preference information, in other words, a profile management system. This system includes a preference information extraction part and a preference information storage part. This system makes it possible to determine, based on a privacy policy, to what level the user discloses to the outside the preference information retrieved from his/her own history.

The second system is a system for obtaining other user's information by matching preference information of a certain user with that of another user. This system includes: a communication space management part which manages a communication space; a privacy policy storage part which manages privacy of a user; and a policy application part which applies the privacy policy. This system determines what is disclosed to whom based on the above-mentioned privacy policy in the preference information retrieved from the user's own history. This system makes it possible to know preferences of a specific person or to search for a person whose preferences match those of the user.

In the present invention, the preference information of the user may include not only a target object and preferences for the target object (positive preferences such as “like” and “favorite”) but also negatives (negative preferences such as “dislike” and “poor”). The preference information as described above can be extracted by use of a technique such as an existing sentiment analysis. Moreover, the user can also create a profile by himself/herself.

According to the present invention, by applying the privacy policy which describes and manages a policy for disclosure of the preference information to the preference information, it is determined whether or not to disclose the information to the third party based on classification as a result of matching by a matching system. As to the examples of the privacy policy, the following can be considered.
1. disclose, to a user who has made a query, only preference information that matches preferences of the user.
2. disclose, to multiple users in a certain room, only preference information common to that of the user himself/herself.

By setting such a privacy policy, disclosure of only the preference information about the preferences matching with those of the other users is allowed and the disclosure is not allowed if the preferences do not match. Thus, the preference information is never disclosed to the third party who has preferences that do not match those of the user.

Moreover, in the case where the privacy policy is described by the user himself/herself, a disclosure level can be set by the user, such as disclosing the information even if the preferences do not match or not disclosing the information even if the preferences match. Moreover, the profile created from the user's action history can be referred to. For example, what kind of preference information exists or what is a target object of the preference information can also be referred to. Moreover, for description of the privacy policy, target object information can also be used together with those described above. For example, an existing thesaurus is used to prevent disclosure when a part of a group of synonyms is set to be a target object. Furthermore, for example, if the thesaurus has a tree structure, it is also possible to adopt a specification method for preventing disclosure when a word below a certain node is set to be a target object.

### BRIEF DESCRIPTION OF THE DRAWINGS

For a more complete understanding of the present invention and the advantage thereof, reference is now made to the following description taken in conjunction with the accompanying drawings.

FIG. 1 is a schematic view showing a state of connection between a virtual space server and client computers.

FIG. 2 is a schematic block diagram showing hardware of the client computer.

FIG. 3 is a schematic block diagram showing hardware of the virtual space server.

FIG. 4 is a logic block diagram showing functions for executing preference matching processing.

FIG. 5 is a flowchart of preference matching processing between individuals.

FIG. 6 is a flowchart of processing for obtaining preference information that can be disclosed.

FIG. 7 is a flowchart of privacy policy application processing.

FIG. 8 is a flowchart of preference matching processing in a communication space.

FIG. 9 shows a screen for registering and editing preference information.

FIG. 10 shows a screen for registering and editing a privacy policy.

FIG. 11 shows an example of disclosing preference information between individuals in a virtual space.

FIG. 12 shows an example of disclosing the preference information between the individuals in the virtual space.

FIG. 13 shows an example of disclosing preference information to a group in a virtual space.

FIG. 14 shows an example of disclosing the preference information to the group in the virtual space.

FIG. 15 shows an example of disclosing preference information in an instant messaging system.

FIG. 16 shows an example of disclosing the preference information in the instant messaging system.

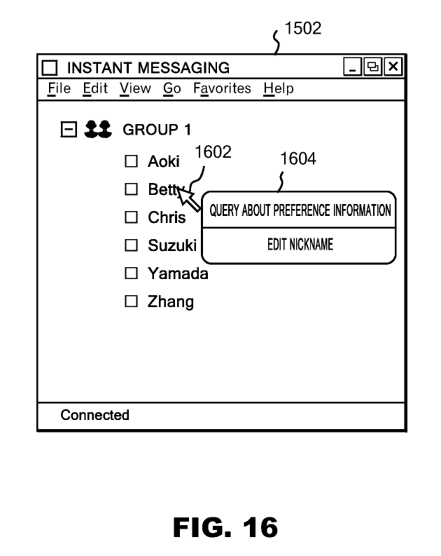

FIG. 17 shows an example of disclosing the preference information in the instant messaging system.

FIG. 18 shows an example of disclosing the preference information in the instant messaging system.

FIG. 19 shows an example of disclosing the preference information in the instant messaging system.

### DETAILED DESCRIPTION OF THE PREFERRED EMBODIMENTS

Hereinafter, embodiments of the present invention will be described with reference to drawings. The same reference numerals shall denote the same components throughout the drawings unless otherwise noted. Moreover, it should be understood that the following description is given of an embodiment of the present invention, and is not intended to limit the present invention to the contents described in the embodiment.

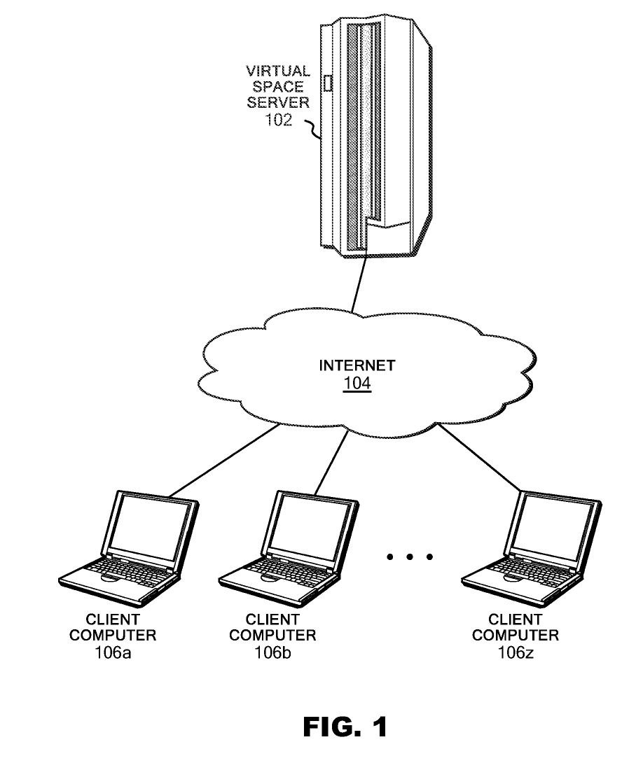

The present invention can be applied to any system in which users interact with each other on a network, such as a SNS, a virtual space and a normal chat system. The following description will be given by taking, as an example, a virtual space server. FIG. 1 is a schematic view showing the entire configuration of a virtual space server serving as the premise of this embodiment. In FIG. 1, multiple client computers 106a, 106b . . . 106z are connected to a virtual space server 102 via the Internet 104.

In a system shown in FIG. 1, users of the client computers log into the virtual space server 102 via the connection of the Internet 104 through a Web browser or a dedicated virtual space browser downloaded from the virtual space server 102.

For the login, each of the users on the client computers uses a given user ID and a password associated therewith. Once the users on the client computers log in, by use of an avatar (not shown in FIG. 1) previously set of their own choosing, they are allowed to move within a virtual space to visit various facilities, and to communicate with other avatars through chatting.

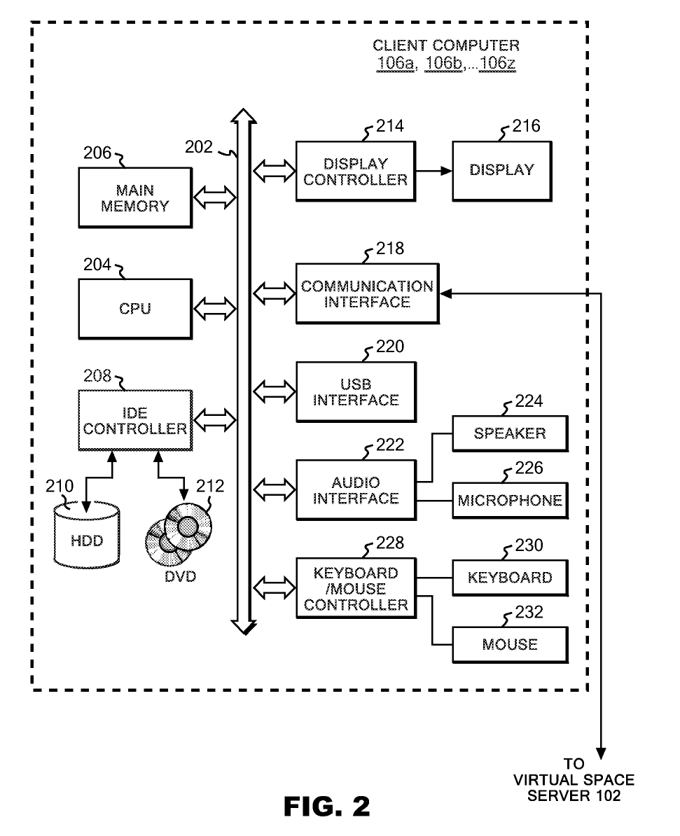

Next, with reference to FIG. 2, description will be given of a hardware block diagram for each of the client computers denoted by reference numerals 106a, 106b . . . 106z in FIG. 1.

In FIG. 2, each of the client computers has a main memory 206, a CPU 204 and an IDE controller 208, all of which are connected to a bus 202. A display controller 214, a communication interface 218, a USB interface 220, an audio interface 222 and a keyboard/mouse controller 228 are further connected to the bus 202. A hard disk 210 and a DVD drive 212 are connected to the IDE controller 208. The DVD drive 212 is used for installing programs from a CD-ROM or a DVD as needed. A display device 216 having an LCD screen is preferably connected to the display controller 214. On the display device 216, avatars, objects and the like transmitted from the virtual space server, to which the computer is connected, are rendered. In this embodiment, rendering is performed not on the server side but on the client side.

A dedicated controller device having particular buttons, an acceleration sensor device and the like are connected to the USB interface 220 as needed, and are used for conveniently operating the avatar within the virtual space.

A speaker 224 and a microphone 226 are connected to the audio interface 222. By providing the client computer with a speech synthesis function, chat contents made by the avatar on the other side can be converted into speech and outputted from the speaker 224 in the virtual space. Moreover, by further providing the client computer with a speech recognition function, contents spoken into the microphone 226 by the user can be converted into text by the speech recognition function and transmitted as chat contents to the avatar on the other side in the virtual space.

A keyboard 230 and a mouse 232 are connected to the keyboard/mouse controller 228. The keyboard 230 is typically used for writing a chat message in the virtual space. Moreover, the keyboard 230 is also used for allowing the avatar to jump and proceed when the dedicated controller is not used. The mouse 232 is used for selecting an operation from a menu and executing the operation in the virtual space or is used for checking and setting object attributes in the virtual space.

Any kind of CPU based on a 32-bit architecture or a 64-bit architecture, for example, may be employed. Specifically, Pentium (trademark) 4 manufactured by Intel Corp., Athlon (trademark) manufactured by AMD Corp. and the like can be used.

The hard disk 210 stores at least an operating system and a virtual space browser (not shown) which is operated on the operating system. The operating system is loaded into the main memory 206 when the system is booted. As for the operating system, Windows XP (trademark), Windows Vista (trademark), Linux (trademark) and the like can be employed.

The communication interface 218 communicates with the virtual space server according to Ethernet (trademark) protocol and the like by utilizing a TCP/IP communication function provided by the operating system.

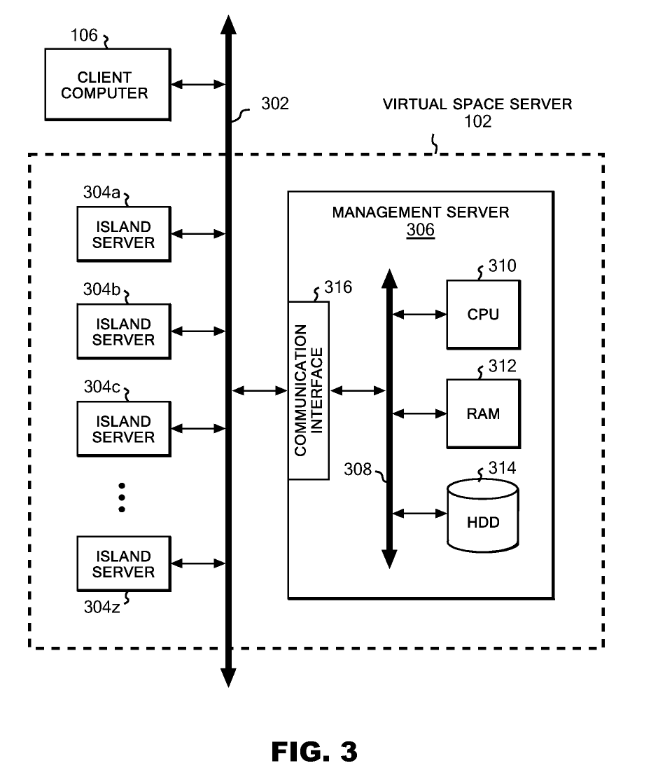

FIG. 3 is a schematic block diagram showing a hardware configuration on a virtual space service provider side. As shown in FIG. 3, a client computer 106 is connected to a communication line 302 via the Internet. Note that, here, the client computer 106 is a collective term for the client computers 106a, 106b . . . 106z shown in FIG. 1, and is actually any one of the client computers 106a, 106b . . . 106z.

The virtual space server 102 shown in FIG. 3 includes island servers 304a, 304b . . . 304z and a management server 306, each of which are connected to the communication line 302 and can communicate with one another. It is preferable that these servers communicate with one another through 1000BASE-T Ethernet (trademark) with a speed of 1000 Mbps.

The management server 306 has a system bus 308, to which a CPU 310, a main storage 312, a hard disk 314 and a communication interface 316 are connected. Although not shown in FIG. 3, a keyboard, a mouse and a display device are further connected to the management server 306, by use of which the management server may perform management and maintenance of the entire virtual space server 102. Alternatively, although also not shown in FIG. 3, the management server may perform management of the entire virtual space server 102 by use of a computer connected to the communication line 302.

The hard disk 314 in the management server 306 stores an operating system and a correspondence table between a user ID and a password for the login management of the client computer 106. Moreover, the hard disk 314 also stores a profile, a privacy policy, a module, and the like, which are to be described in detail later. The profile is created for each user and includes preference information. The module manages the preference information based on the privacy policy.

Each of the island servers 304a, 304b . . . 304z is a server which manages an island of 256 m×256 m (or also called a SIM), for example, in the virtual space. A specific user purchases or rents each one or more of the islands from a manager of the virtual space, and the user as an owner realizes object and access management in his/her unique way by use of the dedicated island server. In terms of scalability, it is preferable to manage each of the islands individually by the respective servers, as described above, so that the virtual space can be extended only by adding island servers. However, the present invention is not particularly limited to the virtual space including multiple islands as described above, but can also be applied to a virtual space of any form which enables multiple users to communicate with each other.

Moreover, the present invention can be applied to not only the virtual space but also any system in which multiple users exchange messages over a network, such as a social networking service and a normal chat on the Internet, which are to be described later.

Note that examples of the management server and island servers described above include, but are not limited to, IBM (trademark) System X, System i, System p and the like, all of which are available from International Business Machines Corporation.

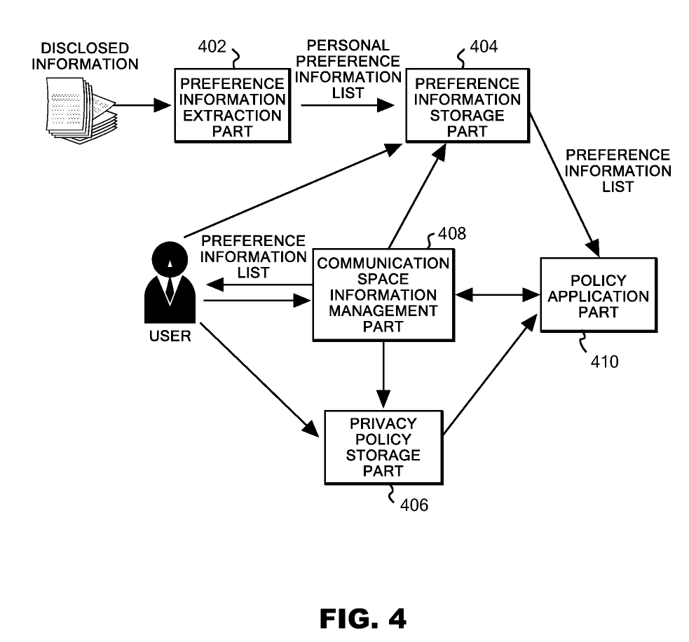

Next, with reference to FIG. 4, description will be given of functions of sub-systems (also called modules) which execute main processes related to the present invention, and of a relationship among the sub-systems. The sub-systems include a preference information extraction part 402, a preference information storage part 404, a privacy policy storage part 406, a communication space information management part 408 and a policy application part 410. It is preferable for the sub-systems to be stored in the hard disk 314 in the management server 306 (FIG. 3), to be accessible by multiple users and to be executed by the CPU 310 after being loaded into the main storage 312 by the operating system as needed.

The preference information extraction part 402 obtains preference information obtained from a document, a user's action history and the like, and inputs the obtained information into the preference information storage part 404. The preference information storage part 404 manages the inputted preference information together with parameters such as time for each user. In the privacy policy storage part 406, each of the users describes, inputs and manages his/her respective privacy disclosure policy. The communication space information management part 408 dynamically retains information about a communication space (for example, a room of a certain building in the virtual space, and the like) in which an avatar operated by the user exists, and provides information as to what kind of a user is present in that space. The preference information matching policy application part 410 carries out application matching by obtaining preference information on two or more users and privacy policies of those users from the respective systems based on the communication space information obtained from the communication space information management part 408. As a result, the preference information is returned to the user or a third party.

Subsequently, the respective sub-systems mentioned above will be described in detail.

### [Preference Information Extraction Part]

In the preference information extraction part 402, description is given of how to extract preference information and how to utilize the extracted preference information. The preference information is information having, as a pair, a target object to be a target of preference and a preference, such as “like” and “dislike”, to the target object.

The preference information extraction part 402 extracts preference information for a certain person X from disclosed information. This disclosed information is the information from which the preference information is extracted, and which can include a disclosed information source such as blogs or private information, such as a personal mail box and files in a personal computer, if disclosure thereof is permitted. Moreover, the disclosed information can also include an activity log file and the like. However, in this case, it is required to be able to identify whose activity log or message in order to identify whose preference information.

As the sub-system, the preference information extraction part 402 includes, or use by calling, a document crawler and an activity log acquisition system as disclosed in Japanese Unexamined Patent Application Publication No. 2005-530224 related to the present applicant, for example, and a preference expression analysis and extraction system as disclosed in Japanese Patent Application Laid-open Publication No. 2006-146567 related to the present applicant, for example. Furthermore, the preference information extraction part 402 may also use a technique of extracting preference information from a document such as a message log described in Japanese Patent Application Laid-open Publication No. 2005-235014 related to the present applicant. The technique described in Japanese Patent Application Laid-open Publication No. 2005-235014 is called a sentiment analysis, which is for searching through a parsed document for spots where expressions related to evaluations are written by use of a declinable word dictionary with attributes such as “like” and “dislike”, and for obtaining a target object based on the parsing result.

As an activity log acquisition system for extracting preference information from an activity log, there is a technique described in Japanese Patent Application Laid-open Publication No. 2006-252207, which uses data obtained by acquiring and managing actions in the real world by use of a portable transmitter in an activity log management system or the like.

Particularly, in the virtual space or 3D Internet according to this embodiment, preference information can be extracted on the basis of an object or an avatar and of an action thereto. For example, considering the case where there is a person who has been wearing a certain object (such as clothes and a hat) for a long period of time, the object is regarded as a target object in this example. Moreover, it can also be assumed, on the basis of the action “wearing for a certain period of time or more”, that there is a preference that the person “likes” the object.

The preference information (Preference Information Object or also described as PIO as its acronym) to be extracted by the preference information extraction part 402 includes a target object and a predicate that expresses user's preference for a target object of a preference information predicate. As an XML expression of the PIO, for example, the target object is described as “TargetObject” and the preference information predicate is described as “predicate”.

```
<PIO>
    <targetObject>animation</targetObject>
    <predicate>like</predicate>
</PIO>
```

Here, targetObject is described in English as “animation”. Alternatively, targetObject may also be described in other languages. Moreover, “like” as predicate that is the preference information predicate may also be described in other language, for instance, as “suki” in Japanese.

### [Preference Information Storage Part]

The preference information storage part 404 includes or calls a thesaurus and a personal preference DB. Although not shown in FIG. 3, the thesaurus and the personal preference DB are stored in the hard disk 314 in the management server 306. A super-subrelation between a preference and a target object category is described in the thesaurus. In the preference information storage part 404, the target object category and the preference provided by the thesaurus are given to the PIO. As the XML expression of the PIO, for example, the target object category provided by the thesaurus is described as “targetObjectCategory”, and the preference is described as “preference”. A value of preference is either Positive or Negative. The personal preference DB stores personal preference information and can receive a query about the personal preference information from the outside. In response to the query, the personal preference DB returns a list of PIOs.

### [Communication Space Information Management Part]

The communication space information management part 408 can set and manage information about a space in which users communicate with each other. Here, the space is an extended concept and is information indicating who (user information) exists when (time information) and where (space information). The space holding this information shall be called a communication space.

In case of a request for disclosure of preference information, the communication space information management part 408 holds types of the request for disclosure of preference information and a list of users sharing the space other than the user to be the target of the preference information. As XML tags, “type” is used for the type of the request for disclosure of preference information and “personInfo” is used for the list of users sharing the space other than the user to be the target of the preference information.

The term “type” is the type of the request for disclosure of preference information, and there are two types, “person” and “communicationSpace”. The term “person” indicates a request from a certain user for disclosure of preference information about another user. The term “communicationSpace” indicates a request from a third party or a user in the communication space for disclosure of preference information about a certain whole group.

The certain group may be determined by a person who sends a disclosure request (by handing over a set of user IDs and the like) and may also be determined dynamically according to positional information retained by the communication space information management part (for example, a user present within a radius of several meters of a certain object). At the same time, the communication space information management part retains, as “personInfo”, information about users (one user in the case of “person” and more than one user in the case of “communicationSpace”) for comparing the preference information with respect to the respective types.

### [Privacy Policy Storage Part]

In the privacy policy storage part 406, a privacy policy for a person to allow or deny a PIO can be described and stored. An XML tag of “privacy_policy” includes the following four basic tags.

Specifically, first, a “permission” tag specifies whether to allow or deny disclosure of privacy information.

A “target” tag specifies a target of disclosure of information (to whom and where disclosure of information is allowed or denied) and a method for disclosing the information.

A PIO tag specifies preference information to be disclosed (what is allowed or denied).

A “condition_list” tag specifies conditions for allowance or denial.

These tags are used in the following XML. Note that those described in <!- . . . -> or after // in the following are comments for explaining this embodiment and are not relevant to actual processing.

<?xml version=”1.0” encoding=”utf-8”?>
<!-
policy for allowing information disclosure to a person who is in
the same communication space and has matching preference
->
<privacy_policy_definitions> // define a privacy policy
<privacy_policy> // unit of privacy policy
<permission>allow</permission> // enter permission of either
allow or deny
<target> // specify a target for disclosing preference information
<person inCommunicationSpace=”yes”/> // indicating that a person
in the same communication space is a target
</target>
<condition_list> // list expressing conditions including “and”,
“or” and “not”
<or> // description of “or” condition
<condition>
<preference_matching type=”matching affinity”/>
</condition>
<condition>
<preference_matching type=”matching antipathy”/>
</condition>
</or> // end of description of “or” condition
</condition_list>
</privacy_policy>
<!-
policy for denying information disclosure to a person who is in
the same communication space and has mismatching preference
->
<privacy_policy>
<permission>deny</permission>
<target>
<person inCommunicationSpace=”yes”/>
</target>
<condition_list>
<or>
<condition><preference_matching type=”opposing
affinity”/></condition>
<condition><preference_matching type=”opposing
antipathy”/></condition>
</or>
</condition_list>
</privacy_policy>
</privacy_policy_definitions>
<?xml version=”1.0” encoding=”utf-8”?>
<!-
policy for allowing information disclosure to a person who is in
the same community space and has matching preference
->
<privacy_policy_definitions>
<privacy_policy>
<permission>allow</permission>
<target>
<person inComminitySpace=”yes”/>
</target>
<condition_list>
<or>
<condition>
<preferenceMatching type=”matching affinity”/>
</condition>
<condition><preferenceMatching type=”matching
antipathy”/></condition>
</or>
</condition_list>
</privacy_policy>
<!-
policy for denying information disclosure to a person who is in
the same community space and has mismatching preference
->
<privacy_policy>
<permission>deny</permission>
<target>
<person inComminitySpace=”yes”/>
</target>
<condition_list>
<or>
<condition><preferenceMatching type=”opposing
affinity”/></condition>
<condition><preferenceMatching type=”opposing
antipathy”/></condition>
</or>
</condition_list>
</privacy_policy>
</privacy_policy_definitions>

With reference to the XML described above, the tags will be described more in detail.

First, the “permission” tag takes any one of two values, “allow” or “deny”. When multiple policies match for the same PIO, priority shall be given to “deny”. Thus, “deny” is basically described only if absolutely no information is to be disclosed (for example, such as a case where none of the information is to be disclosed to a certain person).

As a tag to be entered below the target tag, there are two tags, “person” and “communication space”. In the case of a person tag, the following attributes are retained.

The term “inCommunicationSpace” means whether or not the same communication space is shared, and either “yes” or “no” is entered.

The term “group” indicates whether or not the person is a member of a group previously defined.

The term “role” indicates whether or not the person has a role previously defined, for example, an administrator or the like.

The term “id” indicates an ID for identifying the person.

In the case of a communication_space tag, the following attributes are retained.

The term “role” indicates whether or not the person has a role previously defined, for example, an administrator and the like.

The term “id” indicates an ID for identifying the communication space.

The PIO tag describes which information is to be disclosed. A PIO currently targeted for evaluation of the privacy policy shall be expressed by a variable $currentPIO.

PIO matching conditions are described in “category” attributes. The following functions can be used here.

Category (PIO o): return a category of PIO o.

upperCategory (Category c): return an upper category of Category x.

lowerCategory (Category c): return a list of lower categories of Category c.

Here, a hierarchical structure of categories is assumed.

Moreover, the PIO currently targeted for evaluation can be set to be a target of disclosure by describing no PIO tag.

As an example, in order to allow disclosure of all “preference_matching” for a PIO of an upper category among the categories of the PIO that is currently being evaluated, the following is described.
<PIO category=“upperCategory(category($currentPIO))” preference_matching=“all”/>

Additionally, “mode” attributes are described to specify a PIO disclosure mode. The following values are used.

anonymous: disclose no user ID

named: disclose user ID (default value)

The “condition_list” tag is described by combining multiple conditions with a Boolean algebra using the following three operators.

and: logical sum

or: logical product

not: negation

The individual conditions are described in the “condition” tag. The tags that can be described in “condition” are described below.

preference_matching: specify a matching type of preference information. The matching type is specified by the attribute “type” and can take the following four values.

matching affinity: the other person likes the thing the person likes.

matching antipathy: the other person dislikes the thing the person likes.

opposing affinity: the other person dislikes the thing the person dislikes.

opposing antipathy: the other person likes the thing the person dislikes.

all: all cases mentioned above.

To be more specific, several examples will be described.

### EXAMPLE 1

The following example represents specification of conditions in the case where “preference_matching” of a category “anime” is matching affinity.

<preference_matching type=”matching affinity”>
<category id=”anime”/>
</preference_matching>

### EXAMPLE 2

The following is an example of a policy describing that, if the mutual preference information of “Daimajin Z” matches with each other, all of the preference information on the upper category (“anime”) thereof is to be disclosed.

<privacy_policy>
<permission>allow</permission>
<target>
<person inComminitySpace=”yes”/>
</target>
<PIO category=”upperCategory(category($currentPIO))”
matchingPreference=”all”/>
<condition_list>
<and>
<condition>
<preference_matching type=”matching affinity”/>
</condition>
<condition>
<category id=“Daimajin Z”/>
</condition>
</and>
</condition_list>
</privacy_policy>

### EXAMPLE 3

The following is an example of a policy describing that, if more than half of those in the communication space like “anime”, preference for “anime” is to be disclosed in the communication space.

<privacy_policy>
<permission>allow</permission>
<target>
<communication_space/>
</target>
<condition_list>
<and>
<condition>
<preference_matching type=”matching affinity”/>
</condition>
<condition>
<category id=“anime”/>
</condition>
<condition>
<minimumMatchingRatio value=”0.5”/>
</condition>
</and>
</condition_list>
</privacy_policy>

When there is a request from the outside for a privacy policy of a certain person, this privacy policy is returned.

### [Policy Application Part]

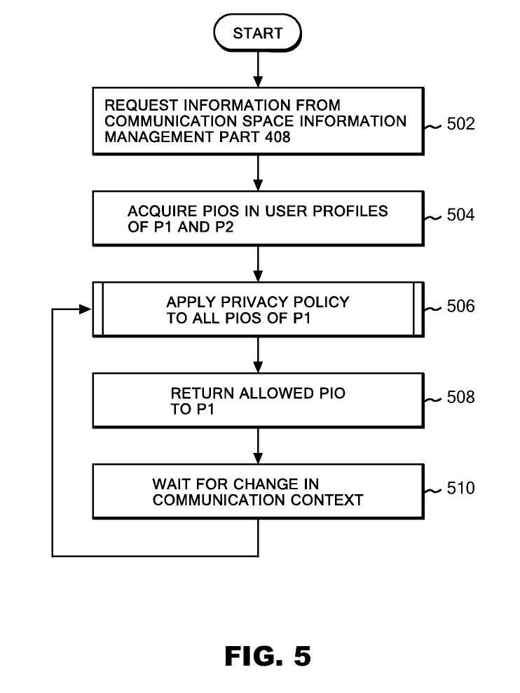

The policy application part 410 applies a privacy policy list obtained from the privacy policy storage part to a preference information list obtained from the preference information storage part 404, and returns the preference information determined to be disclosed to the communication space information management part. With reference to a flowchart shown in FIG. 5, a processing flow of privacy policy application will be described. An example to be described first is a person-to-person preference disclosure request.

In Step 502 shown in FIG. 5, a user (for example, a user P1) requests information about another user (for example, a user P2) in the same communication space from the communication space information management part 408. The communication space information management part 408 sends the request to the policy application part 410.

In Step 504, the policy application part 410 obtains preference information lists (PIO lists) of the users P1 and P2 from the preference information storage part 404. If an accessible user list is set in PIOs of the user P2, only PIOs including the user P1 in the accessible user list are to be acquired.

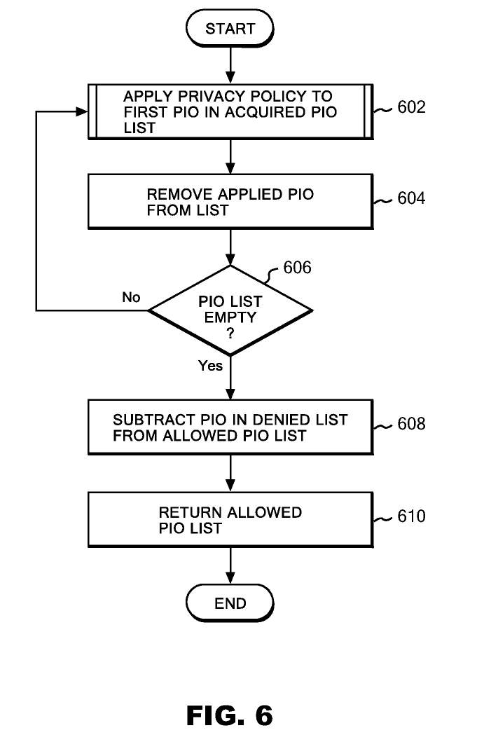

In Step 506, a privacy policy of the user P2 is obtained from the privacy policy storage part 406, and the privacy policy is applied to the obtained respective PIOs of the user P2. Thus, the PIO list of the user P2, which is allowed to be disclosed to the user P1, is obtained. This processing will be described in detail with reference to a flowchart shown in FIG. 6.

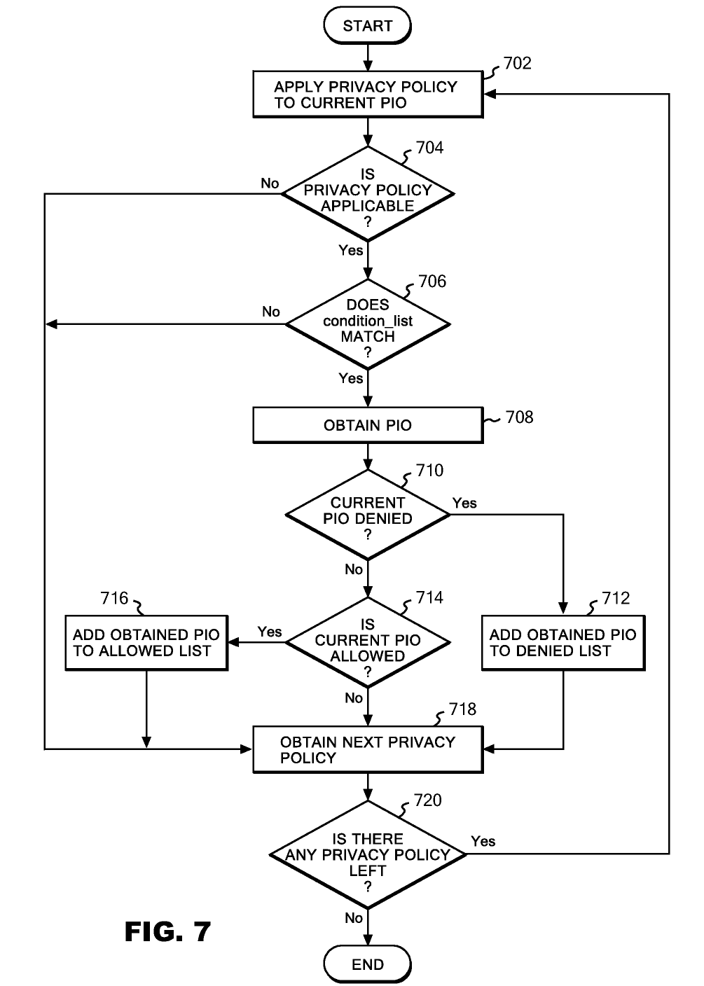

In Step 602 shown in FIG. 6, the privacy policy is applied to the first PIO in the list of PIOs acquired. The detailed processing in Step 602 will be described in detail later with reference to a flowchart shown in FIG. 7.

In Step 604, the PIO to which the privacy policy is applied is removed from the PIO list.

In Step 606, it is determined whether or not the PIO list is empty. If the PIO list is not empty, the processing goes back to Step 602.

When it is determined in Step 606 that the PIO list is empty, a denied list is completed. Then, the processing goes to Step 608, and PIOs in the denied list are removed from the PIO list.

In Step 610, an allowed PIO list thus obtained is returned.

Subsequently, back to Step 508 shown in FIG. 5, the allowed PIO is returned to the user P1. Here, it is preferable to display the allowed PIO on a screen of a client computer of the user P1.

In Step 510, the virtual space server system waits for a change in a communication context. For example, assuming that the user P2 sends a certain message to the user P1 by chatting, the communication space information management part 408 transmits the message to the privacy policy storage part 406. Thereafter, the privacy policy storage part 406 checks if there is a word corresponding to the PIO of the user P2 in the message. If yes, the PIO disclosure/nondisclosure attribute of the word is changed to be disclosed to the user P1. This is because the fact that the user P2 sends the message to the user P1 can be interpreted as an intention to disclose the message to the user P1. This is an example of the change in the communication context.

If there is a change in the communication context, the processing goes back to Step 506 where the changed privacy policy is applied to all the PIOs of the user P1.

In this way, in Step 508, the PIO associated with the word disclosed in the message is presented to the user P1.

Next, with reference to the flowchart shown in FIG. 7, description will be given of the processing of applying the privacy policy to the PIO. This processing corresponds to the details of Step 602 in the flowchart shown in FIG. 6.

In Step 702, application of the privacy policy to the current PIO is attempted. Thereafter, in Step 704, it is determined whether or not the privacy policy is applicable. Here, the determination on the applicability means the following.

Specifically, it is determined whether or not a portion specified from <target> to </target> in <PIO> to </PIO> matches a requested portion specified from <target> to </target>. If those portions do not match, the privacy policy is determined to be not applicable and the processing advances to Step 718. Note that, as to the matching mentioned here, if category($currentPIO) is written in the privacy policy, matching between categories of the words is determined, rather than matching between words of “target”.

When it is determined in Step 704 that the privacy policy is applicable, it is determined in Step 706 whether or not “condition_list” matches.

For example, “condition_list” is described as follows. In the following example, only one condition is described. Alternatively, multiple conditions can be specified between <condition_list> and </condition_list> by sandwiching the conditions between <condition> and </condition>.

If nothing is described in “condition_list”, the preference is assumed to match. Moreover, if the “preference_matching” tag is specified, it is determined whether or not the PIO of the user P2, which is being evaluated, matches that of the user P1 in preference.

<condition_list>
<condition>
<preference_matching type=”matching affinity”/>
</condition>
</condition_list>

For example, assuming that the PIO of the user P2, which is being evaluated, is as follows, then it is checked whether or not there is a matching PIO in the PIOs of the user P1, if “condition_list” of the privacy policy that is being evaluated is as described above. If yes, “condition_list” is assumed to match.
<PIO><target>anime</target><predicate>like</predicate></PIO>

If “condition_list” does not match, the processing advances to Step 718. If “condition_list” matches, a PIO to be a target of disclosure or nondisclosure is obtained in Step 708. If there is no description in the PIO tag in the privacy policy, the one that is currently being evaluated becomes a target PIO. If there is a description in the PIO tag, one or more PIOs of the user P2, which match with the description, are obtained to be target PIOs.

When the target PIO is obtained, it is determined in Step 710 whether or not the current PIO is denied. This determination is made by checking the “permission” tag in the privacy policy. If the value of the “permission” tag is “deny”, the PIO obtained in Step 712 is added to a denied list.

If the result of the determination in Step 710 is NO, it is determined in Step 714 whether or not the current PIO is allowed. This determination is also made by checking the “permission” tag in the privacy policy. If the value of the “permission” tag is “allow”, the PIO obtained in Step 716 is added to an allowed list.

In Step 718, a next privacy policy is obtained. Thereafter, in Step 720, it is determined whether or not there is any privacy policy left that is not yet applied. If there is a privacy policy left that is not yet applied, the processing goes back to Step 702 where the privacy policy is applied to the current PIO.

When all the privacy policies are applied, the result of the determination in Step 720 turns out to be negative. Accordingly, the processing in the flowchart shown in FIG. 7 is completed.

Thus, the allowed and denied lists of PIOs are returned by the processing in the flowchart shown in FIG. 7.

As described above, these allowed and denied lists are used in Step 608 shown in FIG. 6. The reason why the denied list is subtracted from the allowed list in Step 608 once again is because the allowed and denied lists may include an overlapping PIO. Specifically, just the fact that a certain PIO is in the allowed list does not mean the PIO is to be immediately disclosed. If the PIO is also in the denied list, disclosure of the PIO is prevented. Thus, priority is given to the denied list and unintended disclosure is prevented.

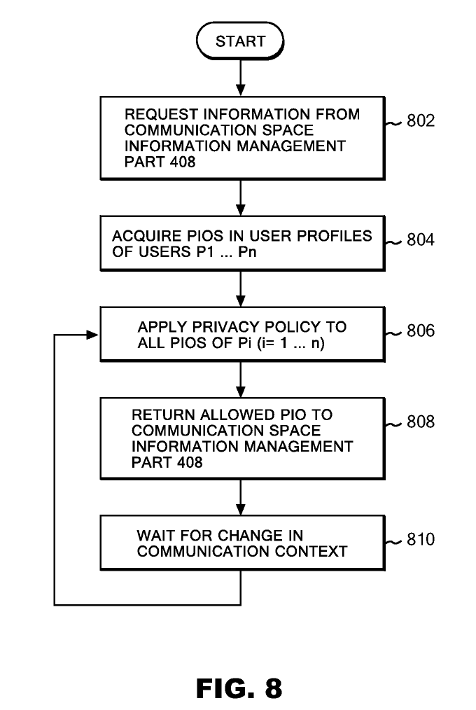

FIG. 8 is a flowchart of processing in the case of obtaining preferences of a group of users.

In Step 802 shown in FIG. 8, a user U requests profiles of users (avatars) P1 . . . Pn in a room within the same virtual space of the user U, for example, from the communication space information management part 408. The communication space information management part 408 hands over the request to the policy application part 410.

In Step 804, the policy application part 410 obtains preference information lists (PIO lists) in the profiles of the users P1 . . . Pn from the preference information storage part 404. If an accessible user list is set in PIOs of Pi (i=1 . . . n), only PIOs disclosed to a third party are obtained.

In Step 806, a privacy policy of a user Pi is applied to each of the PIOs in the profile of the user Pi (i=1 . . . n). Then, it is determined whether or not each of the PIOs is allowed to be disclosed to the third party. Here, to be more specific, the processings as in the flowcharts shown in FIGS. 6 and 7 are performed. However, since the processings are almost the same as those described with reference to the flowcharts shown in FIGS. 6 and 7, description thereof will be omitted. Note that, what is different here is a process of determining what proportion of all the PIOs included in the profile of the user Pi are positive or negative. This proportion, if described in the privacy policy, is used for comparison with the following condition as described in [Example 3] mentioned above.

<condition>
<minimumMatchingRatio value=”0.5”/>
</condition>

After an allowed PIO is thus obtained in Step 806, the allowed PIO thus obtained is returned to the communication space information management part 408. Subsequently, the communication space information management part 408 presents the allowed PIO to the user U by sending the allowed PIO to a client computer of the user U.

In Step 810, the communication space information management part 408 waits for a change in a communication context. If there is a change in the communication context, the processing goes back to Step 806 where reapplication of the privacy policy is executed.

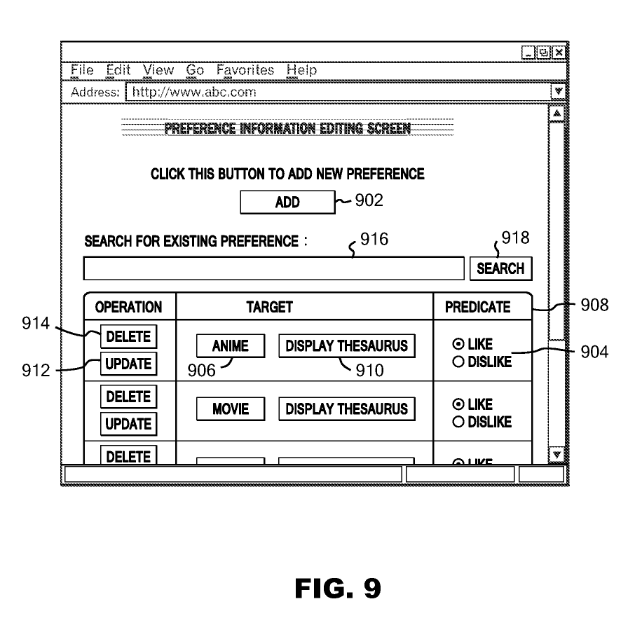

Next, FIG. 9 shows a screen for a user to edit preference information. As described above, it is preferable that the preference information of the user be automatically extracted from the user's blog, the user's web browsing history, information on the user's actions, and the like. Meanwhile, the screen shown in FIG. 9 enables the user to edit the obtained preference information or to add new preference information.

It is preferable that a menu shown in FIG. 9 can be realized on the server 102 by use of JavaScript (trademark) and a CGI using Perl, Ruby or the like. Moreover, the user enters this menu by use of a JavaScript-enabled web browser. Alternatively, the menu can also be described by use of a technique such as PHP, Java (trademark) Servlet and JSP. However, since these techniques are well-known, detailed description thereof will be omitted here. Moreover, the user may also enter the menu shown in FIG. 9 through a dedicated client program rather than through the web browser and JavaScript.

Although not shown in FIG. 9, the users are required to log in first by inputting their own user ID and password to enter this screen.

In FIG. 9, when a button 902 is clicked, a screen for entering a target phrase (not shown) appears. Thereafter, when a phrase is entered into the screen and an OK button (not shown) is clicked, an entry 904 is displayed down below and the entered phrase is displayed in a text field 906. A predicate 908 is a set of alternative radio buttons for either “like” or “dislike”. For example, “like” may be selected as a default. Note that predicates such as “love” and “hate” other than “like” and “dislike” may also be set to be selected.

When a button “display thesaurus” 910 is clicked, a thesaurus dictionary stored in the hard disk 314 is searched in connection with the phrase entered in the text field 906. In this way, a thesaurus for the phrase is displayed. At this stage, the phrase in the text field 906 can be replaced with a phrase in the thesaurus as needed.

If any part of the entry 904 is changed, this changed entry is reflected and saved in the hard disk 314 by clicking an “update” button 912. It is preferable to save a preference entry in the hard disk 314 as data in a content management database (CMDB). Moreover, the entry can be deleted from the content management database by clicking a delete button 914.

Meanwhile, by entering a phrase in a field 916 and clicking a search button 918, phrase entries partially corresponding to the phrase can be listed, and can be edited or deleted as needed.

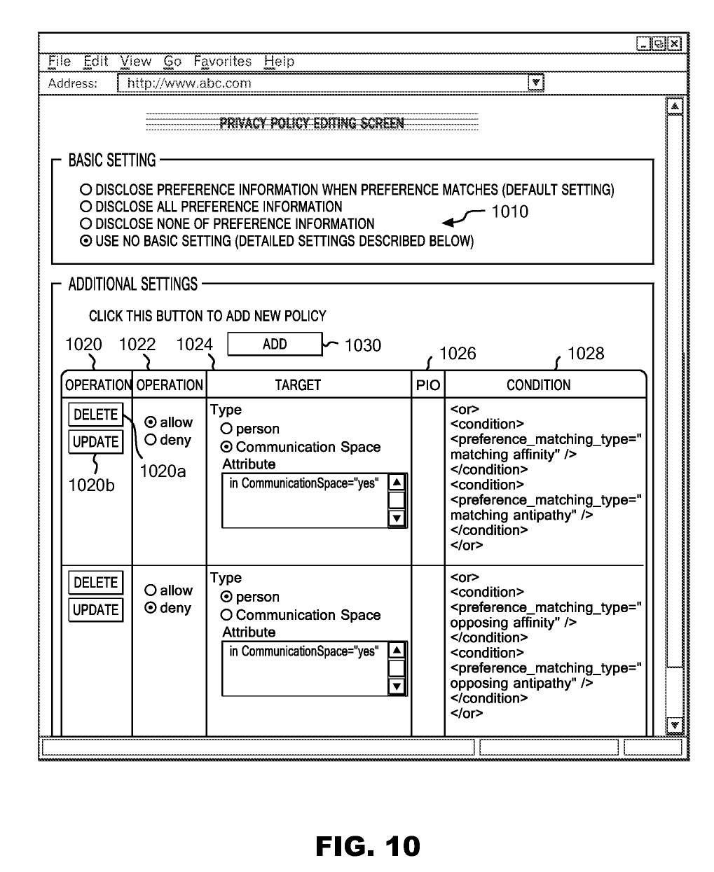

FIG. 10 shows a screen for the user to create or edit a privacy policy. As in the case of the menu shown in FIG. 9, it is preferable that a menu shown in FIG. 10 can also be realized on the server 102 by use of JavaScript (trademark) and a CGI using Perl, Ruby or the like. Moreover, the user enters this menu by use of a JavaScript-enabled web browser. Alternatively, the menu can also be described by use of a technique such as PHP, Java (trademark) Servlet and JSP. Moreover, the user may also enter the menu shown in FIG. 10 through a dedicated client program.

Although not shown in FIG. 10, the users are required to log in first by inputting their own user ID and password to enter the screen.

Note that, as in the case of the preference information, the privacy policy for each user is also stored in the content management database in the hard disk 314 in the management server 306.

The screen shown in FIG. 10 mainly includes a basic setting section and an additional setting section. The basic setting section includes a set of radio buttons 1010 and combinations of characters associated therewith. A phrase “disclose preference information when preference matches (default setting)” is associated with the first radio button. By clicking this radio button, when someone makes a request for disclosure of preference information, the matching preference information is disclosed only if the preference information of the user matches that of the person. This is one of typical processings of the present invention and is set as the default setting. This corresponds to the following privacy policy.

<privacy_policy>
<permission>allow</permission>
<condition_list>
<condition>
<preference_matching type=”matching affinity”/>
</condition>
</condition_list>
</privacy_policy>

By clicking the radio button “disclose all preference information”, all the preference information is disclosed to anyone. This corresponds to the following privacy policy.

<privacy_policy>
<permission>allow</permission>
</privacy_policy>

Moreover, by clicking the radio button “disclose none of preference information”, none of the preference information is disclosed to anyone. This corresponds to the following privacy policy.

<privacy_policy>
<permission>deny</permission>
</privacy_policy>

Furthermore, by clicking the radio button “use no basic setting”, the settings are left to contents described in the additional setting section.

A setting screen for a privacy policy to be additionally set is in table form as shown in FIG. 10. The setting screen includes an operation column 1020, a permission column 1022, a target column 1024, a PIO column 1026 and a condition column 1028.

The operation column 1020 has a “delete” button 1020a and an “update” button 1020b. It is preferable that an appropriate confirmation message having an OK button appear when the “delete” button 1020a is clicked, and that a privacy policy corresponding to the relevant row be deleted from the content management database in the hard disk 314 when the OK button is clicked. When the “update” button 1020b is clicked, contents set on this screen are saved in the content management database in the hard disk 314 and are subsequently reflected for the user.

In the permission column 1022, any one of radio buttons “allow” or “deny” is clicked.

In the target column 1024, a person to whom the user discloses his/her preference information, that is, a target is specified. There are radio buttons for “person” and “communication space”. When “person” is selected, a policy for disclosing preference information to individual users is set. Meanwhile, when “communication space” is selected, a policy for the user to disclose his/her preference information generally to multiple users in the communication space is set. In an Attribute memo field 1024a in the target column 1024, for example, an Id of a specific other user can also be set in the case of preference information disclosure for individual users.

Although the PIO column 1026 is left blank in FIG. 10, for example, one or more conditions of a PIO to be disclosed can be described, such as:

<PIO category=“upperCategory(category($currentPIO))” matchingPreference=“all”/>.

In the condition column 1028, conditions specified in the space from <condition_list> to </condition_list> are described with an XML tag.

When a button 1030 is clicked, an entry for a new privacy policy is created. Thereafter, the privacy policy can be edited as needed and saved in the content management database in the hard disk 314 in the management server 306 (FIG. 3).

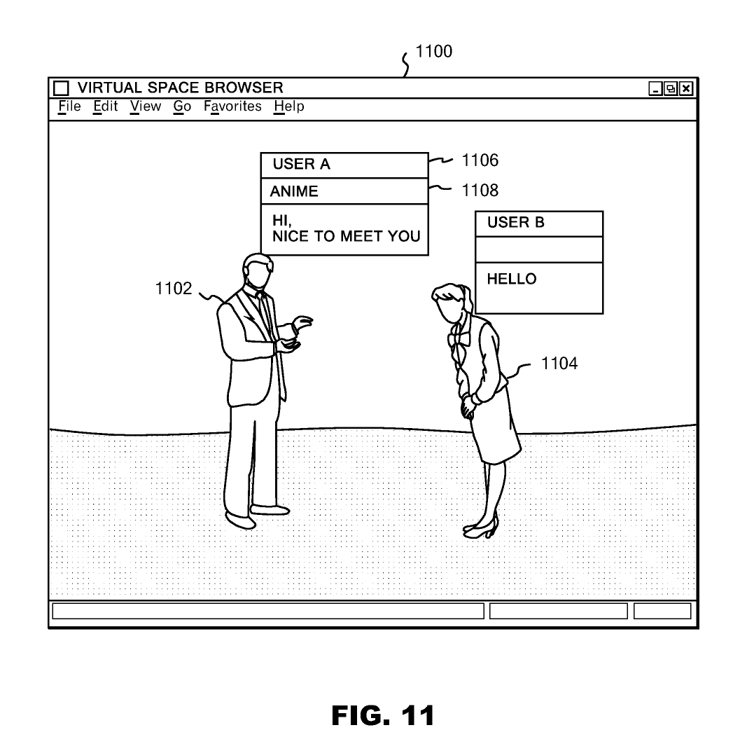

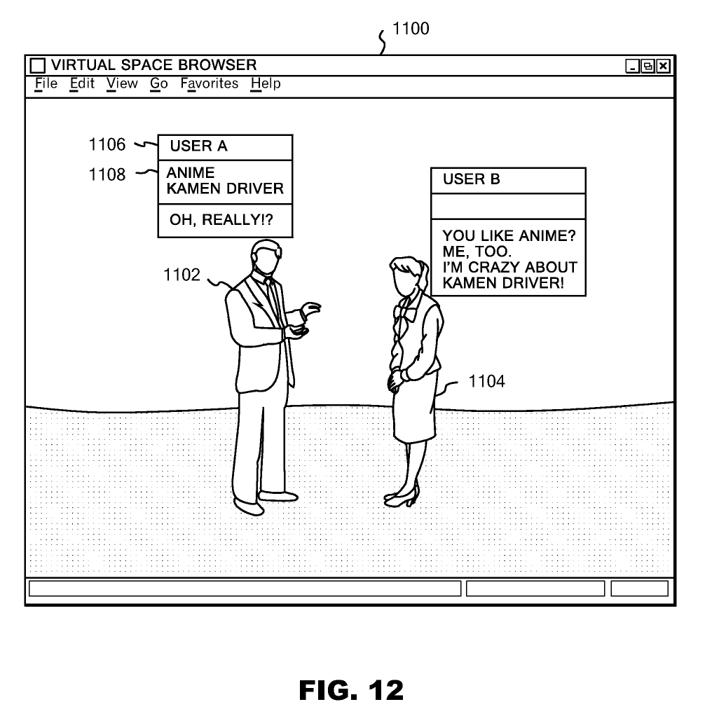

Next, with reference to FIGS. 11 and 12, description will be given of how a user discloses his/her preference information in a virtual space.

FIG. 11 shows a situation where users A and B meet and have a conversation within a virtual space browser 1100. Here, an avatar 1102 of the user A and an avatar 1104 of the user B are displayed.

Let us assume the user A has the following privacy policy.

<privacy_policy_definitions>
<privacy_policy>
<permission>allow</permission>
<target>
<person />
</target>
<PIO category=”anime”/>
</privacy_policy>
<privacy_policy>
<permission>allow</permission>
<target>
<person />
</target>
<PIO category=”Kamen Driver” matchingPreference=”matching
affinity”/>
</privacy_policy>
</privacy_policy_definitions>

Let us further assume that the user A includes at least “anime” and “Kamen Driver” as “like” in a PIO. Meanwhile, according to the privacy policy of the user A, “anime” is set to be disclosed unconditionally to anyone. Thus, “anime” is displayed in a preference disclosure section 1108 in a chat screen 1106 of the user A.

Meanwhile, although a PIO and a privacy policy of the user B will not be described in detail, let us still further assume that there is at least no preference set to be unconditionally disclosed and at least “Kamen Driver” is not included in the PIO of the user B. In this case, since the condition <PIO category=“Kamen Driver” matchingPreference=“matching affinity”/> is not satisfied, “Kamen Driver” is not displayed in the preference disclosure section 1108 of the user B.

In the state where “anime” is displayed in the preference disclosure section 1108 of the user A, the user A says “Hi, Nice to meet you” to the user B through chatting. In response, the user B says “Hello” through chatting.

Here, with reference to the flowchart shown in FIG. 5, the communication space information management part 408 (FIG. 4) waits for a change in a communication context, in other words, monitors a chat message in Step 510. However, at this point, the chat message includes only a greeting sentence. Thus, there is no change in the communication context.

Thereafter, the screen is shifted to FIG. 12 where the user B says “You like anime? Me, too. I'm crazy about Kamen driver!” through chatting. Then, the communication space information management part 408 analyzes this message and assumes that the user B likes Kamen Driver. Accordingly, a PIO including “Kamen Driver” as “like” is stored for the user B in the preference information storage part 404. In response, the user A says “Oh, Really!?”

In response to this change in the communication context, the privacy policy is reapplied in Step 506 in the flowchart shown in FIG. 5. Thus, the condition <PIO category=“Kamen Driver” matchingPreference=“matching affinity”/> is satisfied. Consequently, “Kamen Driver” is displayed in the preference disclosure section 1108.

As a result, the user B finds out that the user A actually likes Kamen Driver, too and thus their conversation can get lively.

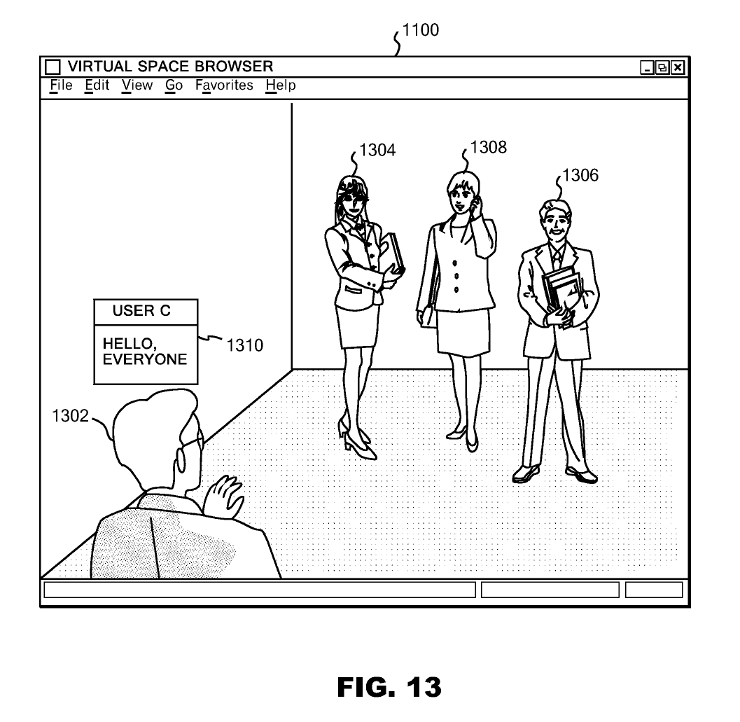

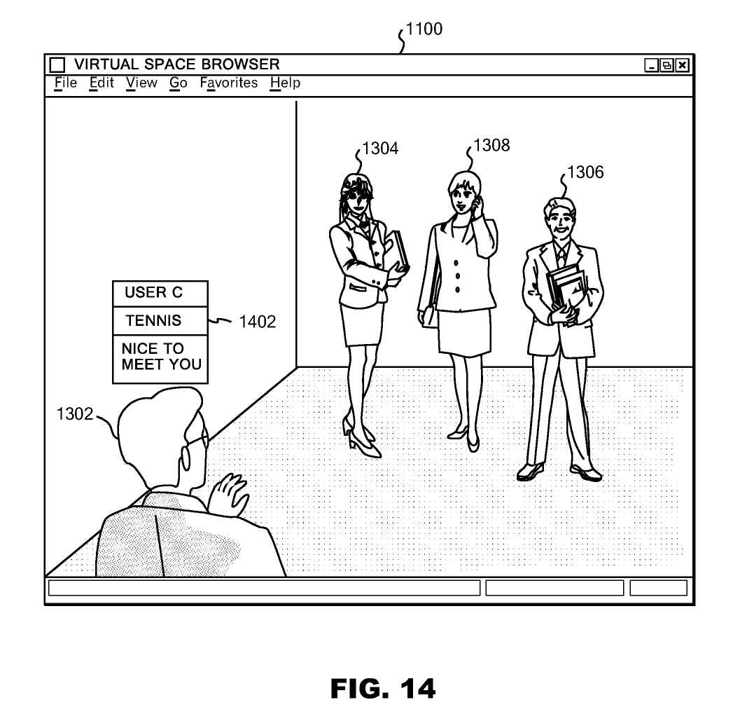

Next, with reference to FIGS. 13 and 14, description will be given of an example of preference information disclosure to a group. Let us assume a user C playing an avatar 1302 talks to users playing avatars 1304, 1306 and 1308 in FIG. 13. In this example, the communication space information management part 408 recognizes that the avatar 1302 and the avatars 1304, 1306 and 1308 are in a room within an identifiable virtual space, which is separated from other space regions. Specifically, the room may or may not be closed.

Here, the user C has the following privacy policy.

<privacy_policy>
<permission>allow</permission>
<target>
<communication_space/>
</target>
<condition_list>
<and>
<condition>
<preference_matching type=”matching affinity”/>
</condition>
<condition>
<category id=“tennis”/>
</condition>
<condition>
<minimumMatchingRatio value=”0.5”/>
</condition>
</and>
</condition_list>
</privacy_policy>

When the user C comes into this room, the user C does not know preference information of the other avatars 1304, 1306 and 1308 in the room. Thus, as shown in FIG. 13, when the user C says “Hello, everyone” through chatting, preference information of the user C is not displayed in a chat message 1310.

Consequently, the user C sends the communication space information management part 408 a query about the preference information of the avatars 1304, 1306 and 1308 in the room. For example, the user C selects a “space preference information query” from a menu (not shown) popped up by clicking a right mouse button on any spot on a display screen of the virtual space browser 1100 in a client computer the user C uses. Thereafter, when a left mouse button is clicked on it, the communication space information management part 408 sends a query to the preference information storage part 404 (FIG. 4). Thus, the preference information of each of the users playing the avatars 1304, 1306 and 1308 is retrieved and confirmed. As a result, let us further assume that the users playing the avatars 1304 and 1306 like tennis and the user C also likes tennis, while the user playing the avatar 1308 does not have any preference information about tennis.

Subsequently, the communication space information management part 408 returns, by performing the processing in the flowchart shown in FIG. 8, information that a proportion of the users who like tennis in the room is ¾=0.75. This information is based on the result that three of the users in the room like tennis while it cannot be determined whether or not the remaining one likes tennis. In response, preference information “tennis” is displayed in a preference information display section 1402 of the user C, since the condition <minimumMatchingRatio value=“0.5”/> is satisfied based on the above-mentioned privacy policy of the user C. Thus, the avatars 1304, 1306 and 1308 find out that the user C likes tennis. Thereafter, based on the information that most of the users in the room like tennis, the users can talk up a storm about a tennis-related topic.

Then, let us still further assume that three new avatars come into the room, and that it is found out that one of the new avatars dislikes tennis and the other two have no preference information about tennis, as a result of sending a space preference information query by the user C. Consequently, a proportion of the users who like tennis in the room, which is returned by the communication space information management part 408, turns out to be 3/7=0.43. Thus, since the condition <minimumMatchingRatio value=“0.5”/> is no longer satisfied, the preference information of the user C shown in FIG. 14 is systematically deleted.

Note that, in the above example, the user performs an explicit operation to make a query about collective preference information of the users (avatars) who stay in the space. Alternatively, the communication space information management part 408 may read the preference information of the users (avatars) who stay in the space, in the case where the avatars stay in the space for a certain period of time or more, and automatically notify the obtained information to the user whose privacy policy includes a spatial policy, in other words, <target><communication_space/></target>.

Moreover, in a situation where multiple users (avatars) stay in a certain room (space), any user (first user) can make a query about personal preference information of another avatar (second user). Specifically, the first user selects “personal preference information query” from a menu (not shown) popped up by clicking a right mouse button on the avatar of the second user. Thereafter, when a left mouse button is clicked on it, the communication space information management part 408 sends a query to the preference information storage part 404 (FIG. 4). Thus, the query about the preference information of the other avatar can be made. In this case, based on the processing in the flowchart shown in FIG. 5, the communication space information management part 408 acquires preference information (PIO) of the first user and that of the second user, and applies a privacy policy of the second user to those PIOs. The PIO returned as a result is sent only to a client computer of the first user. Accordingly, the first user can view the PIO of the second user on the virtual space browser 1100 displayed on a screen of his/her own client computer within a range allowed according to the privacy policy of the second user. It is preferable to display the PIO in a balloon-like shape associated with the avatar of the second user on the virtual space browser 1100. Note that this information is not sent to client computers of the other users in the room. Thus, a PIO information disclosure range is strictly limited.

The processings shown in FIGS. 13 and 14 can also be applied by an organizer of an event to provide advertisement.

Specifically, for example, the following is assumed: A large number of users gather in a theater prepared in a virtual space for a concert of a singer to be held in the virtual space; A CM is played until the concert is started; Thus, the users are wished to spend time until the concert is started in visiting web sites (or shops and the like prepared in the virtual space) of a sponsor of the CM by being guided by the CM. A person who wishes to provide advertisement (an owner of the theater or an advertiser) first obtains IDs of the users in the theater from the communication space information management part 408. Thereafter, a set of the user IDs is specified as a group of users having preference information. Subsequently, statistical information on preferences of the group of the users is obtained.

The obtained information is as follows.
preference targets are hobbies (belonging to “hobby” in the thesaurus)

| | |
|---|---|
| Those who like music | 75% |
| Those who like movies | 20% |
| Those who like sports | 10% |

preference targets are names of people (belonging to “personal name” in the thesaurus)

| | |
|---|---|
| Those who like Rock singer D (male) | 60% |
| Those who like Celebrity E (male) | 30% |
| Those who like Idol F (male) | 25% |
| Those who like Idol G (female) | 2% and others |

When the above information is obtained, there are two ways to provide advertisement to meet the preferences of the users.
1) In the case where there is more than one candidate for advertisement

Let us consider the case where a contract is made with an advertisement distributor and contents of the advertisement can be dynamically changed. Specifically, the preference information obtained shows that, among the users gathering here, there are more users interested in music than those interested in movies or sports. Therefore, promotional campaign for music or portable music players is presented, rather than movie-related or sports-related advertisement.
2) In the case where there is one advertisement target but there are several kinds of advertisement

Let us consider the case where a product to be advertised is already decided but there are several advertisements. The several advertisements mean CMs having a story in which each of the Celebrity A (female idol), Celebrity B (male idol actor) and Celebrity C (actress) tells about features of the same product. It is possible to infer from the obtained preference information that the male celebrity has more advertising effects for the users gathering here than the female celebrity. Thus, the CM with the male celebrity is presented to the users.

Let us consider a situation where, when multiple people (avatars) gather in a virtual space, advertisements (images, videos, objects and the like) suitable for profiles of those people are wished to be provided. The profiles of the people are managed by a server, and the information is not provided to an advertisement provider in terms of privacy. However, if the preference information in that situation is managed by the communication space information management part 408, the advertisement provider can obtain preference information of the gathering people and can provide the most effective advertisement.

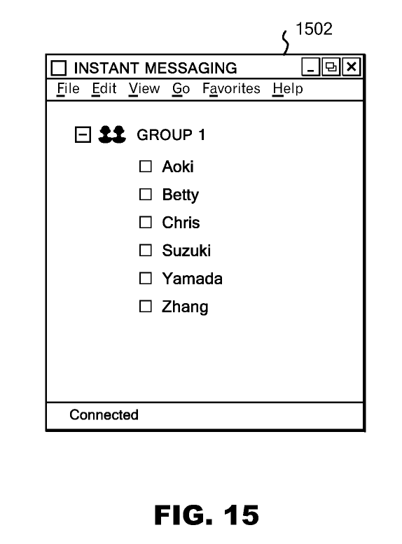

FIG. 15 shows an example of applying the present invention to an instant messaging system. Although not shown in FIG. 15, a server computer in this system includes the equivalent functional module as that described with reference to FIG. 4. Specifically, the preference information storage part 404 stores preference information of users registered in the instant messaging system. Moreover, the privacy policy storage part 406 stores privacy policies of the registered users. In FIG. 15, let us assume that six users Aoki, Betty, Chris, Suzuki, Yamada and Zhang have logged into the instant messaging system and, particularly, a login screen of Aoki is viewed.

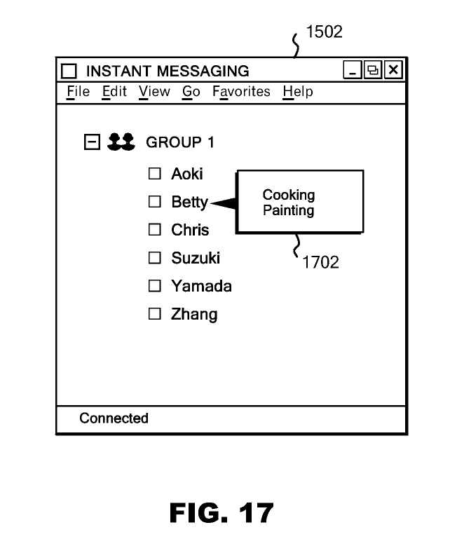

When Aoki moves a cursor to a user ID (here, Betty) displayed and clicks a right mouse button, a menu 1604 including a preference information query is popped up. Thereafter, when Aoki clicks the preference information query in the menu 1604, functions equivalent to those described in the flowchart shown in FIG. 5 are operated. First, preference information of Aoki and Betty are acquired, and then Betty's privacy policy is applied thereto. As shown in FIG. 17, Betty's preference information 1702 that can be presented to Aoki is displayed.

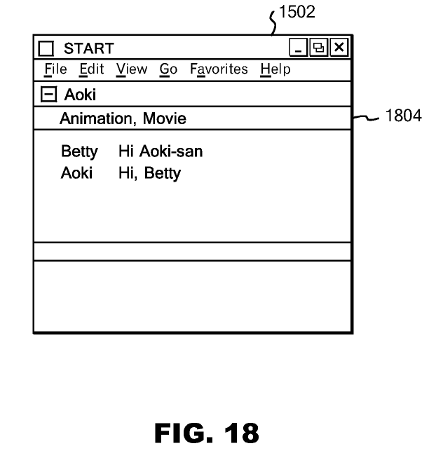

FIG. 18 shows a screen 1802 for Aoki to send a message through the instant messaging system. On this screen, Animation and Movie in Aoki's preference information are displayed in a preference information display section according to Aoki's privacy policy. This is disclosed to any person Aoki will have a chat with.

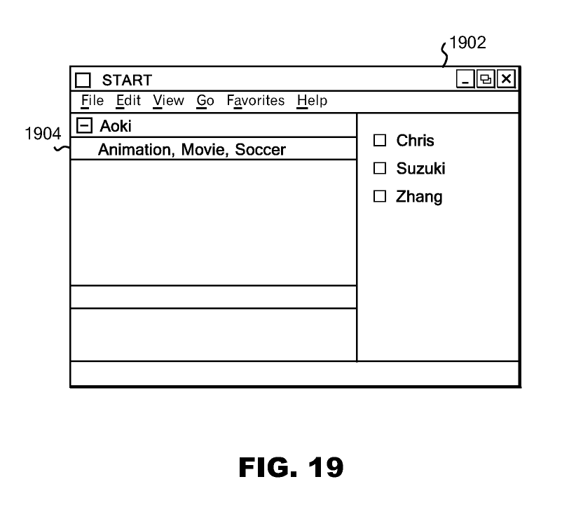

FIG. 19 shows a screen 1902 for chatting among three or more members. In this event, in response to the fact that three or more members are included in a chat screen, preference information of a group engaging in this chat is obtained by the communication space information management part 408 performing the processing in the flowchart shown in FIG. 8. For example, assuming that Aoki has a privacy policy for disclosing that Aoki likes soccer if more than half of the group like soccer, “Soccer” would be displayed in a preference information display section 1904 by the instant messaging system in response to detection that Chris and Suzuki like soccer by the communication space information management part 408.

The present invention is more effectively applied to a social networking service (SNS). The social networking service itself is designed for friends who can trust each other to disclose profiles and interests to each other on a network. This invention enables detailed disclosure setting of preference information so that respective users may disclose their specific hobby to a friend who has a similar hobby, and may also disclose only a popular hobby in a specific community to members in the community, by setting a privacy policy properly.

Although the embodiment of the present invention has been described above according to the examples of the communication, the instant messaging system and the social networking service in the virtual space, the present invention is not limited thereto. It should be understood that the present invention can be applied to any system for multiple users to have interactions with each other on a network.

According to the present invention, description of a privacy policy makes it possible to achieve a meaningful communication by disclosing preference information to others within an intended, limited and detailed range while keeping the preference information undisclosed if the user does not wish disclosure thereof, such as disclosing only preference information matching preferences of the other user or disclosing only preference information common to that of the user when he/she is in a certain user group.

Although the preferred embodiments of the present invention have been described in detail, it should be understood that various changes, substitutions and alternations can be made therein without departing from spirit and scope of the inventions as defined by the appended claims.

What is claimed is:

1. A system, to which a client computer used by a user is connected, having at least one processor for matching user's preferences, the system comprising:
storage means;
means for storing profiles of a plurality of users in the storage means, the profiles including preference information;
means for storing policy information as to whether to allow disclosure of the preference information for each of the plurality of users in the storage means;
means for comparing the stored preference information in the profile of a first user with the stored preference information in the profile of a second user; and
means for disclosing matching preference information to the client computer of the user having the profile of the first user if the profile of the second user includes preference information matching the preference information in the profile of the first user, and also if the policy information allows disclosure of the matching preference information.

2. The system according to claim 1, wherein the preference information includes information about whether to like or dislike a specific target and the matching of the preference information is matching of a target and matching of like or dislike of the target.

3. The system according to claim 2, further comprising:
means for determining whether or not the preferences match by use of information about words of a broader concept of a target word, the words being included in a thesaurus.

4. The system according to claim 1, further comprising:
means for specifying a group including a plurality of users; and
means for comparing the preference information in the profile of the first user with the preference information in the profile of each of the users in the group if the policy allows disclosure of the preference information in the profile of the first user, and for disclosing the preference information in the profile of the first user to each of the users in the group if a proportion of the users having matching preference information is not less than a predetermined proportion.

5. A method for matching a user's preference information stored in storage means by use of a computer to which a client computer used by the user is connected, the method comprising the steps of:
storing profiles of a plurality of users in the storage means, the profiles including preference information;
storing policy information as to whether to allow disclosure of the preference information for each of the plurality of users in the storage means;
comparing the stored preference information in the profile of a first user with the stored preference information in the profile of a second user; and
disclosing matching preference information to the client computer of the user having the profile of the first user if the profile of the second user includes preference information matching the profile of the first user, and also if the policy allows disclosure of the matching preference information.

6. The method according to claim 5, wherein the preference information includes information about whether to like or dislike a specific target and matching of the preference information is matching of a target and matching of like or dislike of the target.

7. The method according to claim 6, further comprising the step of:
determining whether or not the preferences match by use of words of a broader concept of a target word, the words being included in a thesaurus.

8. The method according to claim 5, further comprising the steps of:
specifying a group including a plurality of users; and
comparing the preference information in the profile of the first user with the preference information in the profile of each of the users in the group if the policy information allows disclosure of the preference information in the profile of the first user, and for disclosing the preference information in the profile of the first user to each of the users in the group if a proportion of the users having matching preference information is not less than a predetermined proportion.

9. A program storage device for storing a program for matching a user's preferences stored in storage means by use of a computer to which a client computer used by the user is connected, the program causing the computer to execute the steps of:
storing profiles of a plurality of users in the storage means, the profiles including preference information;
setting policy information as to whether to allow disclosure of the preference information for each of the plurality of users in the storage means;
comparing the stored preference information in the profile of a first user with the preference information in the profile of a second user among the stored profiles; and
disclosing matching preference information to the client computer of the user having the profile of the first user if the profile of the second user includes preference information matching the profile of the first user, and also if the policy allows disclosure of the matching preference information.

10. The program according to claim 9, wherein the preference information includes information about whether to like or dislike a specific target and matching of the preference information is matching of a target and matching of like or dislike of the target.

11. The program according to claim 10, further allowing the computer to execute the step of:
determining whether or not the preferences match by use of words of a broader concept of a target word, the words being included in a thesaurus.

12. The program according to claim 9, further allowing the computer to execute the steps of:
specifying a group including a plurality of users; and
comparing the preference information in the profile of the first user with the preference information in the profile of each of the users in the group if the policy allows disclosure of the preference information in the profile of the first user, and for disclosing the preference information in the profile of the first user to each of the users in the group if a proportion of the users having matching preference information is not less than a predetermined proportion.

13. A server system to which a plurality of client computers are connected via a network, the server system comprising:
means for storing preference information of users of the client computers;
means for storing privacy policy information for each of the users, the privacy policy information including conditions for disclosure of the preference information; and
means for comparing the preference information between first and second users among the users in response to a preference information query to the second user from the first user, and for disclosing matching preference information to the client computer of the second user if the preference information of the first user includes preference information matching the preference information of the second user and if the privacy policy information of the first user specifies disclosure of the matching preference information.

14. The server system according to claim 13, wherein the preference information includes information about whether to like or dislike a specific target and matching of the preference information is matching of targets and matching of likes or dislikes.

15. The server system according to claim 14, further comprising:
means for determining whether or not the preferences match by use of words of a broader concept of a target word, the words being included in a thesaurus.

16. The server system according to claim 13, further comprising:
means for specifying a group including a plurality of users; and
means for comparing the preference information in a profile of the first user with the preference information in the profile of each of the users in the group if the policy allows disclosure of the preference information in the profile of the first user, and for disclosing the preference information in the profile of the first user to each of the users in the group if a proportion of the users having matching preference information is not less than a predetermined proportion.

17. The server system according to claim 13, wherein the server system is a virtual space server system and each of the users operates an avatar in the virtual space server.

18. The server system according to claim 13, wherein the server system is an instant messaging server system and the preference information is presented on a messaging window of an instant messaging system in the client computer.

19. The server system according to claim 16, wherein the server system is a social networking service server system and the group constitutes a community in the social networking service.
